(19) United States
(12) Patent Application Publication
(10) Pub. No.: US 2007/0157072 A1
(43) Pub. Date: Jul. 5, 2007

(54) PORTABLE CONTENT SHARING

(75) Inventor: Maurice Jerome LaBiche, Cary, NC (US)

Correspondence Address: MOORE AND VAN ALLEN PLLC FOR SEMC, P.O. BOX 13706, 430 DAVIS DRIVE, SUITE 500, RESEARCH TRIANGLE PARK, NC, 27709, US

(73) Assignee: SONY ERICSSON MOBILE COMMUNICATIONS AB, Lund (SE)

(21) Appl. No.: 11/306,470

(22) Filed: Dec. 29, 2005

(51) Int. Cl. G06F 15/00

(52) U.S. Cl. 715/501.1

(57) ABSTRACT

The system of the invention comprises creating a bookmark file for a multimedia content file where the bookmark file includes a URL or other address identifier for the content file and a bookmark pointer that identifies a specific location within the content file. To share the selected content with a second user on a second user device, the bookmark file is sent to the second user device where it may be accessed by the second user device to allow the second user device to begin consuming the content at the point set by the bookmark pointer at the first user device. The bookmark file is accessed and the URL or other addressing data is used to access the content file on a content server. The bookmark pointer controls the content displayed.

### BACKGROUND

The invention relates generally to the “podcasting” of content and more particularly to a method and apparatus for facilitating the sharing of selected content.

“Podcasting” describes the process of distributing content to user devices such as personal computers, portable computers, personal digital assistants, wireless phones, portable digital audio players or other electronic devices capable of receiving, storing and playing back content. Audio and video multimedia content files may be distributed via the Internet to a user device that can then digest the content of the downloaded file. The user may pay a subscription fee to access content files or the content may be freely available. The content file may be in the MP3, MP4, AVI formats or any other format. User device software enables the user to play back the downloaded content file.

With current technology, if a first user desires to share particular content with a second user, the link identifying the content file, such as a URL, can be copied by the first user at a first user device and sent to the second user at a second user device via e-mail, short message service (SMS), multimedia messaging system (MMS), instant messaging (IM) or other transport. The second user can then display the entire content file on the second user device by initiating a play command to the content server such as by “clicking” the link. It is often desireable, however, that the second user be directed to a specific portion of the content file such that the second user does not have to display the entire content file. There is no known convenient mechanism for the first user to mark the content file such that it displays the selected content for the second user. As a result, the first user must identify the selected content by manually describing the selected content in an e-mail message or the like and the second user either must attempt to manually locate the selected content or must display the entire content file.

Thus an improved content sharing technology that allows a first user device to provide a bookmark file to a second user device where the bookmark file automatically identifies and plays back the selected content at the second user device.

### SUMMARY

The system of the invention comprises creating a bookmark file for a multimedia content file where the bookmark file includes a URL or other address identifier for the content file and a bookmark pointer that identifies a specific location within the content file. The bookmark pointer may be based on a total of elapsed time or data consumed and is set by the user manually to mark the beginning of the selected content. To share the selected content with a second user on a second user device, the bookmark file is sent to the second user device where it may be accessed by the second user device to allow the second user device to begin consuming the content at the point set by the bookmark pointer at the first user device. Specifically, the bookmark file may be stored in the user device such as in a bookmark or favorites list. The bookmark may also be stored in the users message store inside of a message and be accessed directly from the message. The bookmark may also be stored on a web page or blog and be accessed by other readers of the blog or web site such that the bookmark would be generally available. When the second user desires to display the content, the bookmark file is accessed and the URL or other addressing data is used to access the content file on a content server. The bookmark pointer is used to control the point in the content file from which the display of content begins.

### BRIEF DESCRIPTION OF THE DRAWINGS

FIG. 1 is a block schematic diagram of a communications system and devices including functionality in accordance with an embodiment of the present invention.

FIG. 2 is a flow chart illustrating the method of operation of one embodiment of the present invention.

### DETAILED DESCRIPTION OF PREFERRED EMBODIMENTS OF THE INVENTION

The following detailed description of preferred embodiments refers to the accompanying drawings, which illustrate specific embodiments of the invention. Other embodiments having different structures and operations do not depart from the scope of the present invention.

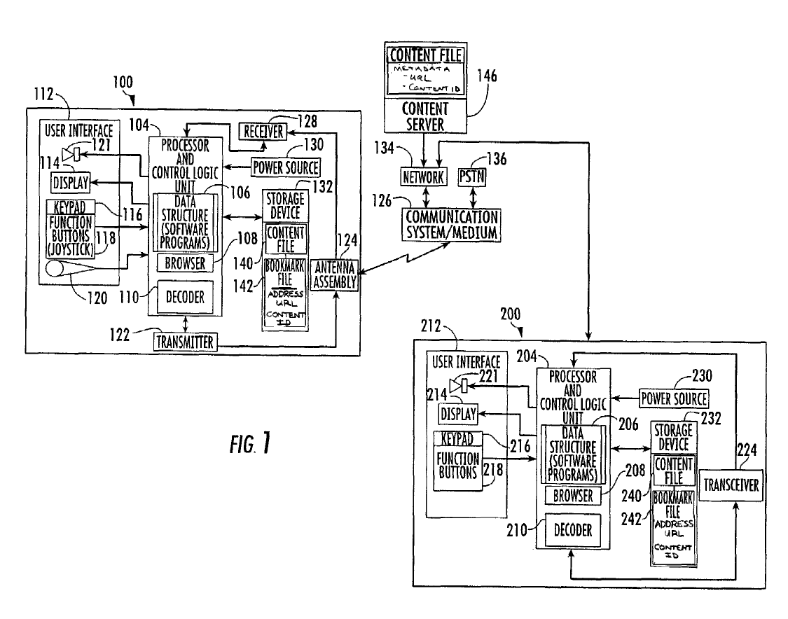

FIG. 1 is a block schematic diagram of an example operating environment of the system of the invention comprising a first user device 100 including functionality in accordance with an embodiment of the present invention. The first user device 100 may comprise a personal computer, portable computer, personal digital assistant, wireless phone, portable digital audio player or other electronic device capable of receiving, storing and playing back a content file. “Play back” and “consume” and variations of these terms as used herein refer to the audio and/or video output of the content of the content file on a user device. The illustrated first user device 100 as described in detail herein is a wireless mobile phone and includes a processor and control logic unit 104. The processor and control logic unit 104 may be a microprocessor or the like. The processor and control logic unit 104 include data structures or software programs 106 including computer-executable or computer-readable instructions to control operation of the communications device 100 and its components. The processor and control logic unit 104 may also include a browser 108.

The first user device 100 may include a user interface 112 to facilitate controlling operation of the first user device 100 including initiating and conducting phone calls and/or other communications. The user interface 112 may include a video monitor or screen 114 to provide a video output and display the content file. The video monitor 114 may be a liquid crystal display (LCD) or the like capable of presenting images. The video monitor 114 provides information to a user or operator in the form of images, text, numerals, characters, a graphical user interface (GUI) and the like. The user interface 112 may also include a keypad 116 and function keys or buttons 118 including a point device, such as a joystick or the like. The function buttons may also comprise soft key pop-up menus. The keypad 116, function buttons and joystick 118 permit the user to communicate commands to the first user device 100 to dial phone numbers, initiate and terminate calls, establish other communications, such as access to the Internet, send and receive email, text messages and the like. The keypad 116, function buttons and joystick 118 may also be used to control the operation of the first user device 100 to enable the functionality of the invention.

The user interface 112 may also include a microphone 120 and a speaker 121. The microphone 120 may receive audio or acoustic signals from a user or from another acoustic source. The microphone 120 converts the audio or acoustic signals to electrical signals. The microphone 120 is connected to the processor and logic unit 104 wherein the processor and logic unit 104 converts the electrical signals to baseband communication signals. The processor and control logic unit 104 is connected to a transmitter 122 that converts baseband signals from the main processor and control logic unit 104 to radio frequency (RF) signals. The transmitter 122 may be connected to an antenna assembly 124 for transmission of the RF signals to a communication medium or system 126.

The antenna assembly 124 receives RF signals over the air and transfers the RF signals to a receiver 128. The receiver 128 converts the RF signals to baseband signals. The baseband signals are applied to the processor and control logic unit 104 which converts the baseband signals to electrical signals. The processor and control unit 104 may send the electrical signals to speaker 121, which converts the electrical signals to audio signals. The speaker 121 may be used to play back the content file.

A power source 130 is connected to the processor and control logic unit 104 to provide power for operation of the communications device 100. The power source 130 may be a rechargeable battery or the like. The communications device 100 also includes at least one data storage device 132. The data storage device 132 may store the content file 140 downloaded from a content server 146 and the bookmark file 142 created by processor and control logic unit 104, as will hereinafter be described. Examples of the content server may include a music library, video library, radio program library, web page library, blog or the like. The data storage device 132 may be a computer-readable medium to store computer-executable or computer-usable instructions or data structures, such as data structures 106, to perform special operations or functions such as those described in accordance with embodiments of the present invention.

The first user device 100 may be operable in association with a communications system or medium 126 in accordance with an embodiment of the present invention. The communications system or medium 126 may be a mobile, wireless, cellular communications system or similar system. The communications system 126 may couple the first user device 100 to another communication network 134 or to a public switched telephone network 136. The wireless terminal may communicate using any communication standard, such as Advanced Mobile Phone Service (AMPS), Digital Advanced Mobile Phone Service (D-AMPS), Global System for Mobile Communications (GSM), Code Division Multiple Access (CDMA), Time Division Multiple Access (TDMA) or the like. The layout and design illustrated in FIG. 1 is for purposes of explaining the present invention and the present invention is not limited to any particular design. While the first user device 100 illustrated in FIG. 1 is a mobile terminal, the present invention may also be applicable to wired or other wireless communication devices and systems.

A second user device 200 including functionality in accordance with an embodiment of the present invention is also shown and may comprise a personal computer, portable computer, personal digital assistant, wireless phone, portable digital audio player or other electronic devices. The illustrated second user device 200 is described as a computer and may include a processor and control logic unit 204. The processor and control logic unit 204 may be a microprocessor or the like. The processor and control logic unit 204 includes data structures or software programs 206 including computer-executable or computer-readable instructions to control operation of the second user device and its components. The processor and control logic unit 204 may also include a browser 208.

The second user device 200 may include an operator or user interface 212 to facilitate controlling operation of the communications device 200. The user interface 212 may include a video monitor or screen 214 to provide video output and play back the content file. The video monitor 214 may be a liquid crystal display (LCD) or the like capable of presenting images. The display 214 provides information to a user or operator in the form of images, text, numerals, characters, a graphical user interface (GUI) and the like. A speaker 221 is also provided for outputting audio signals including play back of the content file. The user interface 212 may also include a keyboard 216 and function keys or buttons 218 including a point device, such as a mouse or the like. The second user device 200 may also be provided with wireless communication functionality such as provided by a Wi-Fi transceiver 224. The keypad 216, function buttons and mouse 218 are used to control the operation of the communications device 200.

A power source 230 may be connected to the processor and control logic unit 104 to provide power for operation of the device 200. The power source 230 may be a rechargeable battery or the like in the case of a lap top computer or portable digital audio player. The power source may also comprise an external power supply. The second user device 200 also includes at least one data storage device 232. The data storage device 232 may be a computer-readable medium to store computer-executable or computer-usable instructions or data structures, such as data structures 206, to perform special operations or functions such as those described in accordance with embodiments of the present invention. The data storage device 232 may store the content file 240 downloaded from a content server 146 and the bookmark file 242 created by process and control logic unit 204 or received from another user device, as will hereinafter be described.

The device 200 may be operable in association with communication network 134 or to a public switched telephone network 136 via a wireless connection, cable modem, dial-up connection or the like. While user devices 100 and 200 have been described with respect to the embodiments disclosed herein it is to be understood that the user devices could have other configurations.

In one embodiment each of the user devices 100 and 200 that operate the system of the invention include decoders or media players 110 and 210, respectively, that are capable of receiving and decoding the standard format of the multimedia content file, such as MP3, received from the content server to produce an uncompressed output of audio and/or video that can be played back to the user on a video screen or via speakers or the like. The decoders act on the content files 140 and 240.

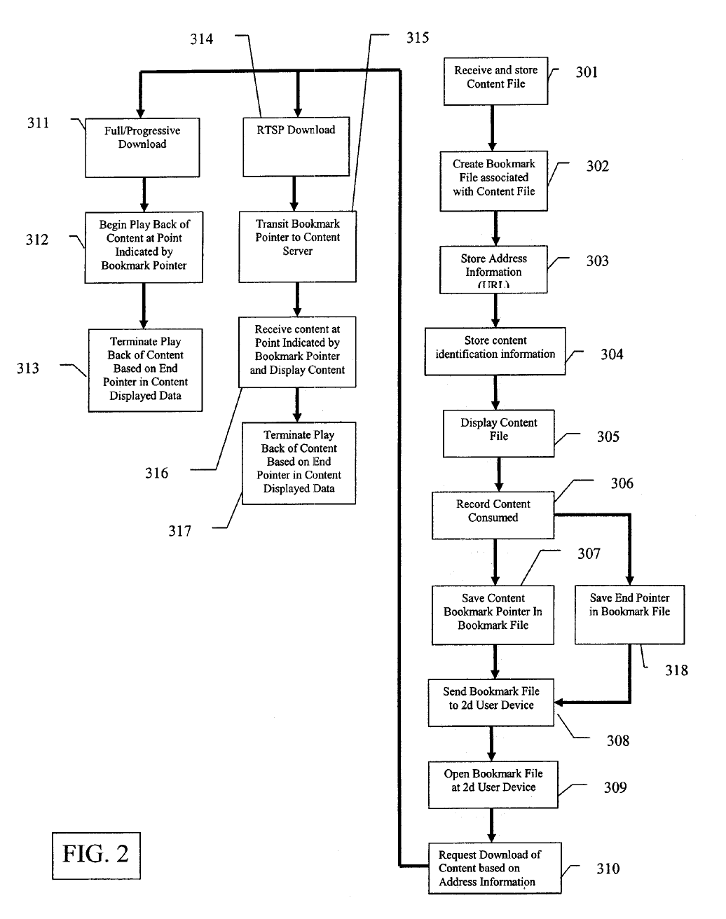

Referring to FIG. 2, when the user desires to obtain podcast content, a multimedia content file is transmitted from the content server 146 to, for example, the first user device 100 over network 134 and/or communications system 126. The transmission of the multimedia content file may be initiated by the user or may be automatically initiated such as through a subscription service. The downloaded multimedia content file 140 is received and stored in data storage 132 (block 301). A metadata wrapper or tag such as the DRM (Digital Rights Management) wrapper currently used with MP3 files transfers encryption and header information such as the URL or other address information, title of content, artist identification and/or other information.

A separate bookmark file 142 is created that is associated with that particular content file (block 302). In one embodiment the bookmark file may be created by the first user device upon receipt of the content file. Alternatively, the bookmark file may be created by the first user device after the user selects the bookmark functionality using the GUI such as function buttons 118. Where more than one content file is saved in data storage 132, each of the content files may have a separate bookmark file created and associated therewith.

As shown in FIG. 1 the bookmark file 142 stores the URL of the downloaded material (block 303). The URL may be obtained from the metadata file downloaded with the content file. While in one embodiment the URL is used, it is to be understood that other address information may be used along with or in place of the URL. It is intended that the address information contained in the bookmark file 142 be sufficient to identify the source of the content file 140 such that by using this address information a user device can request a download of the specific content file from the content server. The bookmark file 142 also may store identification information such that the information may be displayed on the user device to allow a user to identify the source and content of the content file (block 304). This information may include title, source, type of content or the like. The bookmark file 142 also maintains the bookmark pointer information as will hereinafter be described.

When the content in the content file 140 is consumed such as by displaying the content on the user device 100 (block 305) a record of the content consumed is maintained by the processor and control logic unit 104 (block 306). The amount of content consumed by the user device is referred to herein as content consumed data. The content consumed data can be maintained as a running time in for example minutes and seconds, a data consumed tally in for example the number of bytes consumed or a percentage of running time or data consumed or other measure of content consumed.

The bookmark file 142 may save the content consumed data when the user presses a “bookmark” function button that is part of the user interface 112. When the user selects the bookmark function button the system records the content consumed data such as elapsed running time in the bookmark file. The bookmark file 142 captures and saves this content consumed data to create a bookmark pointer that identifies the point in the content file selected by the end user (block 307).

When the user wants to identify the selected content originally selected at the first user device 100 to a second user device 200, the bookmark file 142 is sent from the first user device 100 to a second user device 200 (block 308). The bookmark file may be sent by e-mail, MMS, SMS, IM or other transport. The bookmark may also be stored on a web page or blog where it could be accessed by anyone having access to that web page or blog. The bookmark file 142 is saved at the second user device such as in a bookmark or favorites list (block 309). The bookmark file 240 may be subsequently opened on the second user device 200. The URL or address information in bookmark file 242 is accessed and a download request is made to the addressed content server requesting that the content identified by the URL be downloaded to the second user device (block 310).

Playback of the content in the downloaded content file on the second device 200 begins from the point identified by the bookmark pointer in the bookmark file 242 such that the play back of the selected content can be initiated without the need to manually locate a desired starting point and without having more or less content consumed and displayed than is necessary. The specific mechanism for initiating play back at the point identified by the bookmark pointer may depend on the type of file download used by the content server 146. For example with full download or progressive download the functionality of the bookmark pointer is enabled on the user device (block 311). Full download describes the situation where the entire content of the content file is downloaded to the user device before playback begins. Progressive download describes the situation where the entire content of the content file is downloaded to the user device but play back begins before the entire content file is downloaded such that playback and downloading are occurring at least partially simultaneously. In these situations the user device begins playback of the content at the point indicated by the bookmark pointer by fast forwarding to the point indicated by the content consumed data (block 312). Thus, while the entire file may be downloaded to the user device only the content following the location of the bookmark pointer is actually played on the user device. Content before the bookmark pointer is not played back.

Another type of download is real time streaming protocol (RTSP) (block 314). RTSP is a protocol for use in streaming media systems which allows a client to remotely control a streaming media server, issuing VCR-like commands such as “play” and “pause”, and allowing time-based access to files on a server. Some RTSP servers use RTP as the transport protocol for the actual audio/video data. A request to play content contains the media stream URL and a transport specifier. This specifier typically includes a local port for receiving RTP data (audio or video), and another for RTCP data (meta information). The server reply usually confirms the chosen parameters, and fills in the missing parts, such as the server's chosen ports. A play request will cause one or all media streams to be played. The bookmark pointer is sent to the content server 146 with the play request (block 315) such that the server begins downloading and the user device receives the content at the point designated in the bookmark file (block 316). A play request causes the content to be displayed starting with the point designated in the bookmark pointer. In this mode of operation the bookmark pointer functionality is enabled under the joint operation of the user device and the content server.

In addition to using the bookmark pointer to identify the starting point for play back, an end pointer may be used to indicate the end of the selected content and terminate play back. The end pointer is stored in the bookmark file in the same manner as the bookmark pointer when the user actuates a control button that signals the processor and control logic that the end of the selected content has been reached (block 318). The user device terminates the play back of content at the point designated by the end pointer (blocks 313 and 317). In this manner only the selected content is played back on the second user device.

Specific embodiments of an invention are disclosed herein. One of ordinary skill in the art will recognize that the invention has other applications in other environments. Many embodiments are possible. The following claims are in no way intended to limit the scope of the invention to the specific embodiments described above.

What is claimed is:

1. A file bookmarking apparatus comprising:
a file containing address information of a content file and a bookmark for the content file; and
means for consuming the content from the content file based on the bookmark in the second file.

2. The apparatus of claim 1 wherein the content file is in a standard format.

3. The apparatus of claim 1 wherein the format is one of MP3, MP4 or AVI.

4. The apparatus of claim 1 wherein the file contains a record of elapsed time.

5. The apparatus of claim 1 wherein the file contains a record of consumed data.

6. The apparatus of claim 1 wherein the address information comprises a URL.

7. A method for bookmarking a content file comprising: receiving a content file in a first user device;
creating a bookmark file associated with the content file; and
storing address information for the content file and content consumed data in the bookmark file.

8. The method of claim 7 wherein the content consumed data includes elapsed time.

9. The method of claim 7 wherein the content consumed data includes data consumed.

10. The method of claim 7 wherein the content consumed data includes a percentage of elapsed time.

11. The method of claim 7 wherein the content consumed data includes a percentage of data consumed.

12. The method of claim 7 sending the bookmark file to a second user device.

13. The method of claim 16 using the bookmark file at the second user device to determine where to start the play back of the content file.

14. The method of claim 7 downloading a content file to a second user device based on the address information in the bookmark file.

15. The method of claim 7 wherein the content consumed data is selected by a user.

16. The method of claim 15 wherein the user selects the content consumed data using an interface on the user device.

17. The method of claim 7 further storing an end pointer in the bookmark file that terminates display of content from the content file.

18. The method of claim 12 comprising transmitting the address information and content consumed data to a content server.

19. The method of claim 18 receiving content from the content server corresponding to said address information beginning at the content indicated by the content consumed data.

20. The method of claim 18 receiving the entire content file corresponding to said address and displaying the content of the content file beginning at the content indicated by the content consumed data.
